(19) United States
(12) Patent Application Publication
(10) Pub. No.: US 2014/0278845 A1
(43) Pub. Date: Sep. 18, 2014

(54) Methods and Systems for Identifying Target Media Content and Determining Supplemental Information about the Target Media Content

(71) Applicant: SHAZAM INVESTMENTS LIMITED, (US)

(72) Inventors: James Albert Teiser, San Francisco, CA (US); David Louis DeBusk, Nashville, TN (US); Jason Harvey Titus, Cambridge, MD (US); Ameen Hikmat Abed, San Diego, CA (US); Christopher Thomas Willmore, Tartu (EE); Daniel Carter Hunt, Danville, VA (US); Avery Li-Chun Wang, Palo Alto, CA (US)

(73) Assignee: SHAZAM INVESTMENTS LIMITED, London (GB)

(21) Appl. No.: 13/837,222

(22) Filed: Mar. 15, 2013

(51) Int. Cl. G06Q 30/02

(52) U.S. Cl. CPC G06Q 30/0241
USPC 705/14.4

(57) ABSTRACT

Methods and systems for identifying target media content and determining supplemental information about the target media content are provided. In one example, a method includes determining target media content within a media stream, and determining whether the target media content has been previously identified and indexed within a database. The method also includes based on the target media content being unindexed within the database, determining semantic data associated with content of the target media content. The method also includes retrieving from one or more sources supplemental information about the target media content using the semantic data, annotating the target media content with the retrieved information, and storing in the database the annotated target media content associated with the retrieved information.

### BACKGROUND

Media content identification from environmental samples is a valuable and interesting information service. User-initiated or passively-initiated content identification of media samples has presented opportunities for users to connect to target content of interest including music and advertisements.

Content identification systems for various data types, such as audio or video, use many different methods. A client device may capture a media sample recording of a media stream (such as radio), and may then request a server to perform a search in a database of media recordings (also known as media tracks) for a match to identify the media stream. For example, the sample recording may be passed to a content identification server module, which can perform content identification of the sample and return a result of the identification to the client device. A recognition result may then be displayed to a user on the client device or used for various follow-on services, such as purchasing or referencing related information. Other applications for content identification include broadcast monitoring, for example.

Existing procedures for ingesting target content into a database index for automatic content identification include acquiring a catalog of content from a content provider or indexing a database from a content owner. Furthermore, existing sources of information to return to a user in a content identification query are obtained from a catalog of content prepared in advance.

### SUMMARY

In one example, a method is provided that comprises determining target media content within a media stream, and the media stream comprises a broadcast, and the target media content comprises a commercial. The method also comprises determining whether the target media content has been previously identified and indexed within a database, and based on the target media content being unindexed within the database, determining semantic data associated with content of the target media content. The method also comprises retrieving from one or more sources supplemental information about the target media content using the semantic data. The method also comprises annotating the target media content with the retrieved information, and storing in the database the annotated target media content associated with the retrieved information.

In another example, a non-transitory computer readable medium having stored therein instructions, that when executed by a computing device, cause the computing device to perform functions is provided. The functions comprise determining target media content within a media stream, and the media stream comprises a broadcast, and the target media content comprises a commercial. The functions also comprise determining whether the target media content has been previously identified and indexed within a database, and based on the target media content being unindexed within the database, determining semantic data associated with content of the target media content. The functions also comprise retrieving from one or more sources supplemental information about the target media content using the semantic data, annotating the target media content with the retrieved information, and storing in the database the annotated target media content associated with the retrieved information.

In another example, a system is provided that comprises at least one processor, and data storage configured to store instructions that when executed by the at least one processor cause the system to perform functions. The functions comprise determining target media content within a media stream, and the media stream comprises a broadcast, and the target media content comprises a commercial. The functions also comprise determining whether the target media content has been previously identified and indexed within a database, and based on the target media content being unindexed within the database, determining semantic data associated with content of the target media content. The functions also comprise retrieving from one or more sources supplemental information about the target media content using the semantic data, annotating the target media content with the retrieved information, and storing in the database the annotated target media content associated with the retrieved information.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates one example of a system for identifying content within a data stream and for determining information associated with the identified content.

FIG. 2 shows a flowchart of an example method for annotating content in a data stream.

FIG. 3 illustrates an example content identification method.

FIG. 4 is an illustration of another system for identifying content within a data stream and for determining information associated with the identified content.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

As content recognition capacity increases and as new genres of interesting identifiable content are added to such content recognition systems, content acquisition through manual means can become proportionally cumbersome and unscalable. Additionally, a shelf life of certain genres of content may be short and an amount of time taken to acquire such content manually may not be justifiable. Furthermore, any latency in such content acquisition may result in missed identification opportunities while content is released, e.g. in a broadcast, but not yet in a database for content recognition.

Within examples, automatic target content identification and insertion into a database can be performed. In addition, interesting and relevant enhanced information related to the automatically extracted target content can be acquired, for example, by retrieving content from online sources using metadata extracted from the content or otherwise provided. Target content of interest may be automatically acquired and then annotated with automatically retrieved enhanced associated content. The automated process may reduce the scaling problem of direct content acquisition, as well as the latency in being able to provide the enhanced associated content to an end-user

Example methods are described to identify and extract discrete target media content of interest (e.g. advertisements) from media streams. A collection of related associated content can be assembled from data sources and stored in a database in association with the target media content.

Referring now to the figures, FIG. 1 illustrates one example of a system for identifying content within a data stream and for determining information associated with the identified content. While FIG. 1 illustrates a system that has a given configuration, the components within the system may be arranged in other manners. The system includes a media or data rendering source 102 that renders and presents content from a media stream in any known manner. The media stream may be stored on the media rendering source 102 or received from external sources, such as an analog or digital broadcast. In one example, the media rendering source 102 may be a radio station or a television content provider that broadcasts media streams (e.g., audio and/or video) and/or other information. The media rendering source 102 may also be any type of device that plays or audio or video media in a recorded or live format. In an alternate example, the media rendering source 102 may include a live performance as a source of audio and/or a source of video, for example. The media rendering source 102 may render or present the media stream through a graphical display, audio speakers, a MIDI musical instrument, an animatronic puppet, etc., or any other kind of presentation provided by the media rendering source 102, for example.

A client device 104 receives a rendering of the media stream from the media rendering source 102 through an input interface 106. In one example, the input interface 106 may include an antenna, in which case the media rendering source 102 may broadcast the media stream wirelessly to the client device 104. However, depending on a form of the media stream, the media rendering source 102 may render the media using wireless or wired communication techniques. In other examples, the input interface 106 can include any of a microphone, video camera, vibration sensor, radio receiver, network interface, etc. The input interface 106 may be preprogrammed to capture media samples continuously without user intervention, such as to record all audio received and store recordings in a buffer 108. The buffer 108 may store a number of recordings, or may store recordings for a limited time, such that the client device 104 may record and store recordings in predetermined intervals, for example, or in a way so that a history of a certain length backwards in time is available for analysis. In other examples, capturing of the media sample may be caused or triggered by a user activating a button or other application to trigger the sample capture.

The client device 104 can be implemented as a portion of a small-form factor portable (or mobile) electronic device such as a cell phone, a wireless cell phone, a personal data assistant (PDA), tablet computer, a personal media player device, a wireless web-watch device, a personal headset device, an application specific device, or a hybrid device that include any of the above functions. The client device 104 can also be implemented as a personal computer including both laptop computer and non-laptop computer configurations. The client device 104 can also be a component of a larger device or system as well.

The client device 104 further includes a position identification module 110 and a content identification module 112. The position identification module 110 is configured to receive a media sample from the buffer 108 and to identify a corresponding estimated time position (T_{S}) indicating a time offset of the media sample into the rendered media stream (or into a segment of the rendered media stream) based on the media sample that is being captured at that moment. The time position (T_{S}) may also, in some examples, be an elapsed amount of time from a beginning of the media stream. For example, the media stream may be a radio broadcast, and the time position (T_{S}) may correspond to an elapsed amount of time of a song being rendered.

The content identification module 112 is configured to receive the media sample from the buffer 108 and to perform a content identification on the received media sample. The content identification identifies a media stream, or identifies information about or related to the media sample. The content identification module 112 may be configured to receive samples of environmental audio, identify a content of the audio sample, and provide information about the content, including the track name, artist, album, artwork, biography, discography, concert tickets, etc. In this regard, the content identification module 112 includes a media search engine 114 and may include or be coupled to a database 116 that indexes reference media streams, for example, to compare the received media sample with the stored information so as to identify tracks within the received media sample. The database 116 may store content patterns that include information to identify pieces of content. The content patterns may include media recordings such as music, advertisements, jingles, movies, documentaries, television and radio programs. Each recording may be identified by a unique identifier (e.g., sound_ID). Alternatively, the database 116 may not necessarily store audio or video files for each recording, since the sound_IDs can be used to retrieve audio files from elsewhere. The content patterns may include other information (in addition to or rather than media recordings), such as reference signature files including a temporally mapped collection of features describing content of a media recording that has a temporal dimension corresponding to a timeline of the media recording, and each feature may be a description of the content in a vicinity of each mapped timepoint. For more examples, the reader is referred to U.S. Pat. No. 6,990,453, by Wang and Smith, which is hereby entirely incorporated by reference.

The database 116 may also include information associated with stored content patterns, such as metadata that indicates information about the content pattern like an artist name, a length of song, lyrics of the song, time indices for lines or words of the lyrics, album artwork, or any other identifying or related information to the file. Metadata may also comprise data and hyperlinks to other related content and services, including recommendations, ads, offers to preview, bookmark, and buy musical recordings, videos, concert tickets, and bonus content; as well as to facilitate browsing, exploring, discovering related content on the world wide web.

The system in FIG. 1 further includes a network 118 to which the client device 104 may be coupled via a wireless or wired link. A server 120 is provided coupled to the network 118, and the server 120 includes a position identification module 122 and a content identification module 124. Although FIG. 1 illustrates the server 120 to include both the position identification module 122 and the content identification module 124, either of the position identification module 122 and/or the content identification module 124 may be separate entities apart from the server 120, for example. In addition, the position identification module 122 and/or the content identification module 124 may be on a remote server connected to the server 120 over the network 118, for example.

The server 120 may be configured to index target media content rendered by the media rendering source 102. For example, the content identification module 124 includes a media search engine 126 and may include or be coupled to a database 128 that indexes reference or known media streams, for example, to compare the rendered media content with the stored information so as to identify content within the rendered media content. Once content within the media stream have been identified, identities or other information may be indexed in the database 128.

Thus, the server 120 may be configured to receive a media stream rendered by the media rendering source 102 and determine target media content within the media stream. As one example, the media stream may include a broadcast (radio or television), and the target media content may include a commercial. The server 120 can determine whether this target media content has been previously identified and indexed within the database 128, and if not, the server 120 can perform functions to index the new content. For example, the server 120 can determine semantic data associated with content of the target media content, and retrieve from a source supplemental information about the target media content using the semantic data. The server 120 may then annotate the target media content with the retrieved information, and storing the annotated target media content associated with the retrieved information in the database 128. In the example in which the media stream comprises a television broadcast, target media content may include television commercials, and the server 120 can determine when a new unindexed commercial is broadcast so as to identify and index the commercial in the database 128 with supplemental or enhanced information possibly about products in the commercial.

In some examples, the client device 104 may capture a media sample and may send the media sample over the network 118 to the server 120 to determine an identity of content in the media sample. In response to a content identification query received from the client device 104, the server 120 may identify a media recoding from which the media sample was obtained based on comparison to indexed recordings in the database 128. The server 120 may then return information identifying the media recording, and other associated information to the client device 104.

FIG. 2 shows a flowchart of an example method 200 for annotating content in a data stream. Method 200 shown in FIG. 2 presents an embodiment of a method that, for example, could be used with the system shown in FIG. 1, for example, and may be performed by a computing device (or components of a computing device) such as a client device or a server or may be performed by components of both a client device and a server. Method 200 may include one or more operations, functions, or actions as illustrated by one or more of blocks 202-212. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, flowcharts show functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block in FIG. 2 may represent circuitry that is wired to perform the specific logical functions in the process. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

At block 202, the method 200 includes determining target media content within a media stream. The media stream may comprise a broadcast, and the target media content may comprise a commercial. A computing device may receive the media stream, either via samples of the media stream or as a continuous or semi-continuous media stream, and determine the target media content. Within examples, pattern recognition and classification of content can be used to locate advertisements and other predetermined content within media streams. Media stream information may include audio, video, still images, print, text, etc., and predetermined content may include advertisements or commercials.

In some examples, to determine the target media content within the media stream, media content that has been repeated at least a threshold number of times can be identified. For example, commercials may be broadcast multiple times on one broadcast channel, or across multiple channels. Thus, content that is identified as repeated at least the threshold number of times (either on a given broadcast or across a plurality of broadcast channels) can be labeled as the target media content. Content that is identified as repeated content can be marked for verification of the target content media manually or by a human.

To identify repeated content, any number of methods may be used, such as for example, automatic content identification as described in U.S. Pat. No. 8,090,579, the entire contents of which are herein incorporated by reference. For instance, a screening database may be used to store media content, and a counter can be used to count a number of times that content is broadcast within the media stream based on a comparison to content stored in the screening database. Identification of the content may not be necessary as direct comparison of stored media content in the screening database with newly received broadcast content can be performed.

In other examples, other methods may be used to determine the target media content within the media stream such as identifying blank frames within the media stream as an indication of the commercial, identifying and reading markers within a digital media stream, or identifying and reading any watermarks that indicate a type of content.

In another example, target media content may be pre-filtered from media streams and imported from an external database as pre-identified target media content. For example, commercials can be manually identified and excerpted from a media stream, and manually labeled as a commercial within a database.

In still other examples, the media stream may include multiple types of media content of varying time lengths, and the target media content may be content that has a maximum time length. For example, the target media content may be a commercial within a television broadcast, and a maximum time length of a commercial may be set at two minutes (of course, other time lengths may be used as well). The media stream can be filtered to remove or extract out content that has a time length less than a threshold or a time length of the maximum predetermined time length or less so as to extract all commercials (or so as to likely extract a majority of commercials). Further, based on a type of the content, target media content may be defined as having a time length that is of a certain ratio of time compared to the other types of content within the media stream (such as a few percent for television commercials, or larger amounts when the target media content is defined as other content).

At block 204, the method 200 includes determining whether the target media content has been previously identified and indexed within a database. For example, the server may access the database (which may be internal or external to a system of the server) to compare the target media content with stored content in the database. The server may additionally or alternatively perform a content identification of the target media content, and compare the content identification with indexed content identifications in the database. If a match is found using either method, then the target media content has been previously identified and indexed.

Any number of content identification methods may be used depending on a type of content being identified. As an example, for images and video content identification, an example video identification algorithm is described in Oostveen, J., et al., “Feature Extraction and a Database Strategy for Video Fingerprinting”, Lecture Notes in Computer Science, 2314, (Mar. 11, 2002), 117-128, the entire contents of which are herein incorporated by reference. For example, a position of the video sample into a video can be derived by determining which video frame was identified. To identify the video frame, frames of the media sample can be divided into a grid of rows and columns, and for each block of the grid, a mean of the luminance values of pixels is computed. A spatial filter can be applied to the computed mean luminance values to derive fingerprint bits for each block of the grid. The fingerprint bits can be used to uniquely identify the frame, and can be compared or matched to fingerprint bits of a database that includes known media. Based on which frame the media sample included, a position into the video (e.g., time offset) can be determined.

As another example, for media or audio content identification (e.g., music), various content identification methods are known for performing computational content identifications of media samples and features of media samples using a database of known media. The following U.S. Patents and publications describe possible examples for media recognition techniques, and each is entirely incorporated herein by reference, as if fully set forth in this description: Kenyon et al, U.S. Pat. No. 4,843,562; Kenyon, U.S. Pat. No. 4,450,531; Haitsma et al, U.S. Patent Application Publication No. 2008/0263360; Wang and Culbert, U.S. Pat. No. 7,627,477; Wang, Avery, U.S. Patent Application Publication No. 2007/0143777; Wang and Smith, U.S. Pat. No. 6,990,453; Blum, et al, U.S. Pat. No. 5,918,223; Master, et al, U.S. Patent Application Publication No. 2010/0145708.

In an example, a content identification module may be configured to receive a media stream and sample the media stream so as to obtain correlation function peaks for resultant correlation segments to provide a recognition signal when spacing between the correlation function peaks is within a predetermined limit. A pattern of RMS power values coincident with the correlation function peaks may match within predetermined limits of a pattern of the RMS power values from the digitized reference signal segments, and the matching media content can thus be identified. Furthermore, the matching position of the media recording in the media content is given by the position of the matching correlation segment, as well as the offset of the correlation peaks, for example.

FIG. 3 illustrates another example content identification method. Generally, media content can be identified by computing characteristics or fingerprints of a media sample and comparing the fingerprints to previously identified fingerprints of reference media files. Particular locations within the sample at which fingerprints are computed may depend on reproducible points in the sample. Such reproducibly computable locations are referred to as “landmarks.” One landmarking technique, known as Power Norm, is to calculate an instantaneous power at many time points in the recording and to select local maxima. One way of doing this is to calculate an envelope by rectifying and filtering a waveform directly. FIG. 3 illustrates an example plot of dB (magnitude) of a sample vs. time. The plot illustrates a number of identified landmark positions (L₁ to L₈). Once the landmarks have been determined, a fingerprint is computed at or near each landmark time point in the recording. The fingerprint is generally a value or set of values that summarizes a set of features in the recording at or near the landmark time point. In one example, each fingerprint is a single numerical value that is a hashed function of multiple features. Other examples of fingerprints include spectral slice fingerprints, multi-slice fingerprints, LPC coefficients, cepstral coefficients, and frequency components of spectrogram peaks.

Fingerprints of a recording can be matched to fingerprints of known audio tracks by generating correspondences between equivalent fingerprints and files in the database to locate a file that has a largest number of linearly related correspondences, or whose relative locations of characteristic fingerprints most closely match the relative locations of the same fingerprints of the recording. Referring to FIG. 3, a scatter plot of landmarks of the sample and a reference file at which fingerprints match (or substantially match) is illustrated. After generating a scatter plot, linear correspondences between the landmark pairs can be identified, and sets can be scored according to the number of pairs that are linearly related. A linear correspondence may occur when a statistically significant number of corresponding sample locations and reference file locations can be described with substantially the same linear equation, within an allowed tolerance, for example. The file of the set with the highest statistically significant score, i.e., with the largest number of linearly related correspondences, is the winning file, and may be deemed the matching media file. In one example, to generate a score for a file, a histogram of offset values can be generated. The offset values may be differences in landmark time positions between the sample and the reference file where a fingerprint matches. FIG. 3 illustrates an example histogram of offset values. The reference file may be given a score that is equal to the peak of the histogram (e.g., score=28 in FIG. 3). Each reference file can be processed in this manner to generate a score, and the reference file that has a highest score may be determined to be a match to the sample.

Still other examples of content identification and recognition include speech recognition (transcription of spoken language of target media content into text) and person identification (speaker identification when a voice is present or facial recognition).

Thus, referring back to FIG. 2, content identification may be performed to determine whether the target media content has been previously identified and indexed in the database.

At block 206, the method 200 includes based on the target media content being unindexed within the database, determining semantic data associated with content of the target media content. Thus, when the target media content has not been indexed (i.e., the target media content is new content), semantic data associated with content of the target media content can be determined. For example, metadata used to label a commercial with a product being advertised, a service being advertised, or a company being advertised can be identified. Additionally, direct content within the target media content that identifies the content can be determined, if present, including text, a phone number, closed captioning, a URL, XML, JSON, a QR code, or other direct labeling in the content itself can be extracted. In other examples, audio, video, and still image excerpts of the target media content can be extracted and identified (using any of the content identification methods described herein) to determine additional semantic data about the target media content.

In some examples, the semantic data may describe the content in the media being broadcast. When the media is a television broadcast, semantic data may include data that indicates a subject of a commercial, a name of any actor/actress in the commercial, identifying information of a scene of the commercial, a product about which the commercial is advertising or other relationships between the content of the media stream and labels used to identify the content.

In some examples, the target media content may have metadata associated therewith that indicates semantic data as well.

At block 208, the method 200 includes retrieving from one or more sources supplemental information about the target media content using the semantic data. For example, the semantic data may be used to retrieve the supplemental information from an internet source. Supplemental information may indicate further data about content of the target media content as well as data about products that differ from a product being advertised in the commercial and are within a class of products as the product being advertised in the commercial, or within a class of a service or a company being advertised. As an example, the target media content may be a commercial about a car, and supplemental information about the car can be retrieved by performing internet searches using search queries populated with the semantic data (e.g., terms including “car” or a brand of the car, or an image of the car). The supplemental information may include a URL to a website featuring the car or a company of the car, or links to ads for other similar cars.

Thus, the semantic content and metadata can used to retrieve related enhanced information from online sources and databases, and further examples of enhanced information include information from product review websites, information from informational websites, information from commerce and purchasing opportunities, or information related to local ads based on geo-location (e.g., national television ad of a car brand links to ad of a local car dealership not mentioned in ad and based on a location of a requesting client device). Further examples of enhanced information include information from social media (and possibly a registration to “follow” commentary (posts) from experts, pundits, and other tastemakers), content from fans, producers, and other stakeholders of the extracted target (ad) content, promotions, coupons, URLs, or recommendations of similar items.

At block 210, the method 200 includes annotating the target media content with the retrieved information. For example, the retrieved information may be associated with the target media content in any way, such as by modifying or generating metadata linking the retrieved information to a recording or a sample of the target media content. In further examples, the method 200 includes performing a content identification of the target media content, and annotating the target media content with the content identification.

At block 212, the method 200 includes storing in the database the annotated target media content associated with the retrieved information. The database may thus be updated to include indexed, identified, and information enhanced copies of the target media content. In an example where the database represents a database of commercials, the database can be updated on a continual basis to include information about new commercials. In this way, the system may be able to serve information about all commercials to client devices in response to receiving a sample of the target media content from the client device.

In further examples, the method 200 includes collecting data regarding a number of content identification queries received for the target media content, or collecting data regarding use of the retrieved information by the computing device. As an example, statistical data can be collected about user queries of acquired target content (e.g., ads), and interactions from the client device may be studied for patterns and trends (e.g., how much interest the user shows in the content through clicking through provided links to enhanced content). This data may be provided to advertisers and broadcasters, audience measurement organizations, etc.

In further examples, the method 200 may include providing an interface configured to receive modifications of the supplemental information used for annotating of the target media content. Supplemental information that is retrieved may be modified based on preferences of a company that is associated with the commercial. Thus, companies may subscribe to a service to view retrieved supplemental information (or supplemental information provided as a default in response to queries from client devices) about their commercial, and modify the supplemental information as desired (possibly so as to remove references to competitor products or unrelated products).

FIG. 4 is an illustration of another system for identifying content within a data stream and for determining information associated with the identified content. A server 402 receives a media stream from the media/data rendering source 404 and extracts target media content (which may be predetermined, such as commercials within a television broadcast), and then accesses a database 406 to determine if the extracted content has been previously indexed and annotated. The extracted content can be identified or may have any number of associated identifiers that can be matched with identifications or identifiers in a table 408 of the database 406. When the content is unindexed in the database 408, the server 402 may access, through a network 410 for example, a number of sources 412a-n to pull in additional information about products and related information of content of the target media content. As an example, for a car commercial, the server 402 may determine a brand of a car being advertised through content identification, and then retrieve supplemental information such as a link to results in an internet search engine for the car, information about car dealerships, etc. The server 402 may then annotate the retrieved information with the target media content and add the newly identified and indexed media to the table 408.

Using the system in FIG. 4, content within genres of fast-moving content can be identified and annotated in a way to make all types of content broadcast by the media rendering source 404 open to content recognition for client devices. The system is configured to automatically populate the database 406 of genres/information based on extraction of new content and link to enhancement of metadata, and to use this information to provide identifiable material and end results to a client device. As an example, a client device may record and provide a sample of a media stream from an ambient environment (as rendered by the media rendering source 404) to the server 404, and may receive in response a direct content identification and enhanced content associated with the identified target (ad) content. The results can be formatted and displayed by the client device. A variety of pieces of enhanced content may be received and displayed, including a thumbnail representing the target content (e.g., still image of a video segment). A user may then interact with the presented content by clicking through links, such as for example, to find out more, register, comment, purchase, get recommendations, etc.

As one specific example, a user may view a commercial with calls to action, and by utilizing a mobile device to sample the commercial, audio can be recognized and the user can be presented with a one-click solution to act on the calls to action. Examples include a television commercial calls out “call 1-866 . . . for a . . . ”, and content recognition provides a one-click solution to recognize the content, and initiate a phone call; a television commercial calls out “like us on social media . . . ”, and content recognition provides a one-click solution to a social media webpage to “like”; a television commercial calls out “#social media HashTag”, and content recognition provides a one-click solution to “#social_media_HashTag” conversation; a television commercial calls out “visit us on www.[website].com”, and a content recognition provides a one-click solution to initiate a web browser and open the webpage; and a television commercial for a car dealer calls out “schedule a test drive . . . ”, and a content recognition provides a one-click solution to schedule test drive at local dealer (either via sending an e-mail, accessing a scheduling procedure on a webpage, initiating a phone call, etc.).

In examples above, calls to action are described as received from television commercials, and providing a one-click solution to act on those calls to action. In additional examples, a user may view a commercial and record a sample using a mobile device such that with one-click on the device, the commercial audio is recognized and the user can be presented with extended data from the commercial. For instance, a television commercial for a product may be viewed, and content recognition can provide a one-click solution to research (i.e., webpage providing product reviews); a television commercial may be viewed, and content recognition may provide a one-click solution to recognize celebrities in the commercial; a television commercial may be viewed, and content recognition may provide a one-click solution to discover music in the commercial; and a television commercial may be viewed, and content recognition may provide a one-click solution to discounts or coupons for products in the commercial.

Within any of the examples above or described herein, enhanced content may be derived from a number of sources. Examples include content entered manually by humans, content inferred based on metadata values, content received from searches based on metadata values, or content received from API calls to a third party services based on metadata values.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
determining target media content within a media stream, wherein the media stream comprises a broadcast, and wherein the target media content comprises a commercial;
determining whether the target media content has been previously identified and indexed within a database;
based on the target media content being unindexed within the database, determining semantic data associated with content of the target media content;
retrieving from one or more sources supplemental information about the target media content using the semantic data;
annotating the target media content with the retrieved information; and
storing in the database the annotated target media content associated with the retrieved information.

2. The method of claim 1, wherein determining the target media content within the media stream comprises:
identifying media content within the media stream that has been repeated at least a threshold number of times; and
labeling the repeated media content as the target media content.

3. The method of claim 2, wherein determining the target media content within the media stream comprises identifying that the media content has been repeated at least the threshold number of times across a plurality of broadcast channels.

4. The method of claim 1, wherein determining the target media content within the media stream comprises identifying blank frames within the media stream as an indication of the commercial.

5. The method of claim 1, wherein the media stream comprises a plurality of media content of varying time lengths, and wherein determining the target media content within the media stream comprises selecting media content that has a time length less than a threshold.

6. The method of claim 1, wherein determining the semantic data associated with content of the target media content comprises identifying metadata used to label the commercial with one or more of a product being advertised, a service being advertised, and a company being advertised.

7. The method of claim 1, wherein determining the semantic data associated with content of the target media content comprises identifying within the target media content direct content that identifies the content including one or more of text, phone number, closed captioning, URL, XML, JSON, and a QR code.

8. The method of claim 1, wherein determining the semantic data associated with content of the target media content comprises identifying one or more of audio, video, and still image excerpts of the target media content.

9. The method of claim 1, wherein retrieving from one or more sources supplemental information about the target media content using the semantic data comprises retrieving the supplemental information from one or more internet sources, and wherein the supplemental information indicates further data about content of the target media content as well as data about one or more products that is different from a product being advertised in the commercial and is within a class of products as the product being advertised in the commercial.

10. The method of claim 1, further comprising:
performing a content identification of the target media content; and
annotating the target media content with the content identification.

11. The method of claim 1, further comprising providing an interface configured to receive modifications of the supplemental information used for annotating of the target media content.

12. The method of claim 1, further comprising modifying the supplemental information that is retrieved based on one or more preferences of a company that is associated with the commercial.

13. The method of claim 1, further comprising:
receiving from a computing device a sample of the target media content; and
in response, providing the retrieved information to the computing device.

14. The method of claim 1, further comprising collecting data regarding a number of content identification queries received for the target media content.

15. The method of claim 14, further comprising:
providing, in response to a query from a computing device, the retrieved information to the computing device; and
collecting data regarding use of the retrieved information by the computing device.

16. A non-transitory computer readable medium having stored therein instructions, that when executed by a computing device, cause the computing device to perform functions comprising:
determining target media content within a media stream, wherein the media stream comprises a broadcast, and wherein the target media content comprises a commercial;
determining whether the target media content has been previously identified and indexed within a database;
based on the target media content being unindexed within the database, determining semantic data associated with content of the target media content;
retrieving from one or more sources supplemental information about the target media content using the semantic data;
annotating the target media content with the retrieved information; and
storing in the database the annotated target media content associated with the retrieved information.

17. The non-transitory computer readable medium of claim 16, wherein retrieving from one or more sources supplemental information about the target media content using the semantic data comprises:
retrieving information indicating one or more of a product being advertised, a service being advertised, or a company being advertised.

18. The non-transitory computer readable medium of claim 16, wherein retrieving from one or more sources supplemental information about the target media content using the semantic data comprises:
retrieving information about one or more products that is different from a product being advertised in the commercial and is within a class of products as the product being advertised in the commercial.

19. A system comprising:
at least one processor;
data storage configured to store instructions that when executed by the at least one processor cause the system to perform functions comprising:
determining target media content within a media stream, wherein the media stream comprises a broadcast, and wherein the target media content comprises a commercial;
determining whether the target media content has been previously identified and indexed within a database;
based on the target media content being unindexed within the database, determining semantic data associated with content of the target media content;
retrieving from one or more sources supplemental information about the target media content using the semantic data;
annotating the target media content with the retrieved information; and
storing in the database the annotated target media content associated with the retrieved information.

20. The system of claim 19, wherein determining the target media content within the media stream comprises receiving a recording of the target media content that was broadcast within the media stream, wherein the recording has associated metadata, and
wherein retrieving from one or more sources supplemental information about the target media content using the semantic data comprises performing internet searches with the metadata to identify supplemental information about the target media content.
